(19) United States
(12) Patent Application Publication
(10) Pub. No.: US 2021/0319365 A1
(43) Pub. Date: Oct. 14, 2021

(54) Methods of Developing Predictive Analytics from Progressions of Comparative Analyses of Base case vs. hypothetical Alternative cases

(71) Applicant: Carl Ernest Kent, Palo Alto, CA (US)

(72) Inventor: Carl Ernest Kent, Palo Alto, CA (US)

(21) Appl. No.: 17/300,157

(22) Filed: Apr. 2, 2021

Related U.S. Application Data
(60) Provisional application No. 63/101,005, filed on Apr. 13, 2020.

(51) Int. Cl. G06N 20/00; G06Q 50/34; G06F 17/18

(52) U.S. Cl. CPC G06N 20/00; G06F 17/18; G06Q 50/34

(57) ABSTRACT

A system and methods for producing and modeling predictive data analytics for forecasting future performance in the context of multi-dimensional, sub-datasets via an automated back-end application computer server, comprising: (a) at least one internal data source storing data collected by the enterprise; (b) at least one third-party data source external to the enterprise; (c) a data store containing electronic records created in accordance with data from both the internal data source and the third-party data source, each electronic record representing an association for an entity in connection with a plurality of relationships, wherein each electronic record contains a set of record characteristic values; (d) the back-end application computer server, coupled to the data store, programmed to: (i) search, fetch, and access the electronic records in the database using a uniquely defined a team and player Identity (ID) numbering algorithm to associate, arrange, store, retrieve, compare, and manipulate player profiles containing data and analytics to associate and track player statistics by their team+position+order on roster depth charts to enable “apple-apple” (i.e., same player position, same player depth on roster depth chart) comparison and substitutions of player statistics between teams, (ii) automatically designate a first sub-set of the set of record characteristic values of each electronic record as fixed effect variables, (iii) automatically designate a second sub-set of the set of record characteristic values of each electronic record as random effect variables, (iv) generate, by a data analytics mixed effect predictive model based on the fixed effect variables and the random effect variables, a future performance estimation value.

In one of several embodiments, the present invention delivers predictive sports player/team fit scores via underlying roster modeling based on 87% historically accurate predictive hard and soft skills analytics (controlled for historically pooled leaguewide data, including, but not limited to, National Basketball Association (NBA), National Football League (NFL), Major League Baseball (MLB), National Hockey League (NHL), Major League Soccer (MLS), and English Premier League (EPL) data on age, injury, minutes played, and load management).

### CROSS-REFERENCE TO RELATED APPLICATION

The present invention claims the preferred beneficial filing date of Apr. 13, 2020 associated with related provisional utility patent filing application 63/101,005.

### STATEMENT REGARDING FEDERALLY SPONSORED RESEARCH AND DEVELOPMENT

Not applicable.

### TECHNICAL FIELD

The present disclosure relates generally to methods of composing predictive analytics. Specifically, the present disclosure relates to methods of developing predictive analytics from progressions of comparative analyses of base case vs. hypothetical test cases. One application of methods disclosed herein is the prediction of the optimal mix of sports team players in the context of assigned rotations on a team roster based on a progression of analyses of historical individual player performance data.

### PRIOR ARTS-U.S. PATENTS

U.S. patent Documents

| | | |
|---|---|---|
| 10/607,144 | March, 202 | Doddi, et al |
| 10/590,670 | March 2020 | Peng et al. |
| 7,409,357 | August 2008 | Schaf et al. |
| 8,260,638 | September 2012 | McNamee et al. |
| 8,666,786 | March 2014 | Wirz et al. |
| 2008/0126139 | May 2008 | Prendergast |
| 2015/0100353 | April 2015 | Hughes et al. |

### BACKGROUND

A variety of non-contextual predictive analytics have, over the last 3 to 5 years, become adopted by a growing number of sports teams and have proven effective in predicting functional roster matches that outperform heuristic methods. Most methods are based on hypothetical additions and subtractions of players from existing rosters, based on individual players' quantified performance.

Although predictive analytics have been adopted for use in, and have presented many positive attributes for sports team roster analysis, substantial improvements are possible. While many professional sports teams have adopted “moneyball” sports analytics, athletes and teams alike continually seek empowering brand management and commerce analytical tools to drive roster quality, fan enthusiasm, and revenue.

With a common architectural approach of hypothetical additions and subtractions of players from existing rosters based on individual players' quantified performance, current sports analytics models are inhibited and fall far short of optimality. For instance, under prior arts methods, existing sports analytics are developed without the context of how players would perform in a given team's roster rotation (a mix of players simultaneously playing within the roster), failing to call into account, how a hypothetically added or subtracted player's historical performance data would compliment strengths or compensate for weaknesses in the context of an existing roster rotation.

Additionally, under prior arts methods, sports analytics are developed based on one dimensional analyses of how given players might hypothetically fit one team's objectives. This “one team-many players” modeling approach leaves out the possibility of one player's statistical data sets being modeled against the rosters of many teams. Further, because of the focus on simple roster addition and subtraction, without aide of rotation sub-analysis, existing sports analytics methods easily result in user mis-interpretation of the accuracy and reliability therein.

Also, with the emergence of so-called “wearables” (electronic data capture devices that are worn on the body), there is a dearth of valuable physiological bio data and periodic changes in such data (heart beat rate, blood pressure, PH level). Such data is not present for analysis in current sports analytics methods, thereby reducing the richness, robustness, and accuracy of resulting predictive analytics. For instance, in the case of a basketball player analysis, the inclusion of such historical physiological bio data may show trends of increasing or decreasing ability to facilitate peak work demand as a possible predictor of future performance, in addition to traditional analytics focus on points, rebounds, field goal percentage, etc.

In addition, most sports analytics methods are based on cumbersome user interface/user experience (UI/UX) that render a tedious, friction-filled, time consuming, and complex encounter, discouraging usage.

The sheer volume of data available through transactional logs, social media, web traffic and other sources provides many opportunities to become a data driven organization. Moreover, the ability to model and learn from the data allows entities to adapt to changing environments and situations. However, to capitalize on this data is not that straightforward, and often requires highly-skilled data scientists to build and test models, and the process of using large, diverse and dynamic datasets to derive insights is tedious, costly and time consuming.

Further, the process of consuming data from different sources and changing data requirements is an added overhead in the project which can affect development and implementation timelines. As such, many business entities are incapable of modeling the business problem, building and testing models that address the problem, and producing actionable results without highly specialized experts.

With the presence of large scale, lightening fast computing power developed on ever shrinking chip sets, software modelling of historical and predictive data analytics has evolved/For example, a system for performance estimating by utilizing a data analytics predictive model is disclosed in U.S. patent application Ser. No. 1,599,670 (Peng, et al). Under this system a specific claim is loss prevention by the commonly accepted and practiced means, predating the cited art, of regressing historical related data sets. The novel approach claimed in Peng centers on an association of fixed effect variables with data subsets. While Peng claims a type of association of fixed effect variables with types data subsets, the art is not all inclusive of an exhaustive list of the many types of fixed effect variables or the many types of data subsets. Nor does Peng address approach of multi-directional regressions of data sets as currently provided in the current art.

In U.S. Pat. No. 7,409,357 Schaf et al disclose a method for massaging Poisson data distributions, utilizing alternate techniques so as to cut off extreme tails that might signal outliers or substantial noise, variability and risks in datasets.

Under U.S. Pat. No. 10,607,144 (Doddi et al.), an approach to modeling data analytics sets forth claims around a series of regressions of data sets in progressive rounds, while inserting, in a controlled manner, separate but related data into data sets. While Doddi claims a method, not all methods of regressing datasets. As in the case of Peng, nor does Doddi address approach of multi-directional regressions of data sets as currently provided in the current art.

Therefore, there clearly exists a need for a system of methods which develops both robust historical and predictive analytics from progressions of comparative analyses of base case vs. hypothetical test cases, in multi-dimensional, sub-roster rotational context, including non-traditional data sets, with analytics input and presentation performed in a low friction UI/UX manner that increases usage and intelligence. Such a system would provide user's quick and reliable access to online contextual predictive analytics with minimal cost.

For these and other reasons, improvements are desirable.

### SUMMARY

In accordance with the present disclosure, the above and other problems are solved by the following:

Benefits: 1) There is a difference; simplified, friction-free, actionable intel is key to success 2) Accuracy 3) Immediacy 4) Empowerment/Personalized Data Management 5) Optimal Matches

### Simplified, Frictionless, Actionable Intel

### Fast, Accurately Distilled Optimal Roster Matchup Scenarios

Facilitates timely Decision Support

### Empowers Users to Proactively Guide Career Movement

### Advantages

1) Context: multi-dimensional, sub-roster rotational context to optimize hypothetical roster matches.
2) Robust Historical and Predictive Modeling Inclusive of Non-Traditional Data: Inclusive of non-traditional data sets. For instance, in the case of a basketball player analysis, the inclusion of such historical physiological bio data may show trends of increasing or decreasing ability to facilitate peak work demand as a possible predictor of future performance, in addition to traditional analytics focus on points, rebounds, field goal percentage, etc.
3) Low Friction Access: analytics input and presentation performed in a low friction UI/UX manner that increases usage and intelligence. Collapses friction filled layers of access to negotiating data.
4) Converts Data-to-Insights-to Roster Moves
5) Optimizes Roster Matches, Team Searches, and Contract Negotiations

In a first aspect, as discussed in detail in paragraphs 44b and 50, the present invention discloses a system and methods for modeling predictive data analytics produced by a series of statistical regressions in the context of multi-dimensional, sub-datasets. In statistical modeling, regression analysis is a set of statistical processes for estimating the relationships between a dependent variable (often called the ‘outcome variable’) and one or more independent variables (often called ‘predictors’, ‘covariates’, or ‘features’). By way of mathematical expression,

Y(i)=f(X(i)i,B)+e(i);

Y(i)=dependent variable
f=function
X(i)=independent variable
B=unknown parameters
e(i)=error terms
Regression analysis is a reliable method of identifying which variables have impact on a topic of interest. The process of performing a regression allows you to confidently determine which factors matter most, which factors can be ignored, and how these factors influence each other.

### Statistical Methods for Finding the Best Regression Model

Adjusted R-squared and Predicted R-squared: Generally, you choose the models that have higher adjusted and predicted R-squared values . . . .
P-values for the predictors: In regression, low p-values indicate terms that are statistically significant.
   The Least Squares Regression Line is the line that makes the vertical distance from the data points to the regression line as small as possible. It's called a “least squares” because the best line of fit is one that minimizes the variance (the sum of squares of the errors).
   Correlation is a single statistic, or data point, whereas regression is the entire equation with all of the data points that are represented with a line. Correlation shows the relationship between the two variables, while regression allows us to see how one affects the other.
   The present invention uniquely creates a pathway for regressing data sets in two directions (forward and reverse regression) to lay sub-roster data sets in a variety of rotational contexts, in the process, uniquely discovering underlying data relationships useful in creating accurate predictions of how data will behave against a backdrop of fixed and variable conditions. In this first aspect, as an example, forward regression is delivered in the modality of teams searching for players, with said regression method being uniquely performed in the context of team roster position depth (first string, second string, third string, etc. . . . ), as independent variables with said regression method uniquely and consequentially enabled by the present invention's Composite Database IDs to associate, arrange, store, search, fetch, retrieve, compare, and manipulate player profiles containing data and analytics (unique team and player Identity (ID) Number Definition). Regarding database layout, starting with the National Basketball Association (NBA) and similarly prepared for the National Football League (NFL), Major League Baseball (MLB), and the National Hockey League (NHL), after player data is imported to the present invention database from a 3^{rd} party application programmer interface (API), the present invention normalizes said data beginning with associating the API supplied Player Name (located in the 3^{rd} party API imported player profile) and nominal Player ID (located in the API data stream) to the present invention's unique composite player ID. In paragraphs 44b and 50 are further detailed explanations of the present invention's unique Composite team and player identity (Composite ID) Number Definition. The purpose of the present invention's unique Composite ID is to associate and track player stats by their team+position+order on roster depth charts to enable “apple-apple” (i.e., same player position, same player depth on roster depth chart) comparisons and substitutions of player statistics between teams. In this first aspect, as an example, reverse regression is delivered in the modality of players searching for teams, with said regression method being uniquely performed in the context of team roster position depth (first string, second string, third string, etc. . . . ), as independent variables with said regression method uniquely and consequentially enabled by the present invention's Composite IDs to associate, arrange, store, search, fetch, retrieve, compare, and manipulate player profiles containing data and analytics (unique Composite team and player identity (Composite ID) Number Definition). As discussed in paragraph 50, note that the script generated regression is produced in the context of roster position depth and is controlled for independent variables player age, and pooled historical age-driven factors for injury, minutes played, and load management,

In a second aspect, the system uniquely utilizes robust modeling inclusive of non-traditional datasets. For instance, in the case of a basketball player analysis, the inclusion of such historical physiological bio data may show trends of increasing or decreasing ability to facilitate peak work demand as a possible predictor of future performance, in addition to traditional analytics focus on points, rebounds, field goal percentage, etc.

In a third aspect, to use the system, a user first inputs data commands to drive the creation of analytics, the execution and presentation of which is uniquely performed in a low friction UI/UX manner that increases usage and intelligence. Collapses friction filled layers of access to negotiating data. As a result, the present invention UI/UX is in stark contrast with that of prior art approaches that sag under the sheer volume of data available through transactional logs, social media, web traffic and other sources. Under prior arts. to capitalize on data is not straightforward, and often requires highly-skilled data scientists to build and test models, and the process of using large, diverse and dynamic datasets to derive insights is tedious, costly and time consuming.

In a fourth aspect, the methods disclosed uniquely enable users to model and learn from data allowing them to adapt to changing environments and situations, including converting data-to-insights to roster moves.

In a fifth aspect, the disclosed methods uniquely optimize dataset pairing, searches, and decision making, by way of example, roster matches, team searches, and contract negotiations

All publications, patents, and patent applications cited herein are hereby incorporated by reference in their entirety for all purposes.

### BRIEF DESCRIPTION OF THE DRAWINGS

FIG. 1 depicts Key Factors for Depth Chart Composition

FIG. 2 is a schematic diagram of a Database Setup+Cache Data: Sample League: NBA Team1 Rotational Depth Chart: Frame 1

FIG. 3 is a schematic diagram of a Database Setup+Cache Data: Sample League: NBA Team1 Rotational Depth Chart: Frame 2

FIG. 4 is a schematic diagram of a Database Setup+Cache Data: Sample League: NBA Team1 Rotational Depth Chart: Frame 3

FIG. 5 is a pictorial view of a Database Setup+Cache Data: Sample League: NBA Team1 Rotational Depth Chart: Frame 225

FIG. 6a depicts a schematic diagram of Contextual Attributes Database Setup+API feed+Cache: Extract, Transfer, Load to Databases in FIGS. 2-5: Ranked Attributes by NBA Team by Context of Player by Position: Sample Team 1, Players 1-5, positions 1-5

FIG. 6b is a pictorial view of a Database Sample League: NBA Player Composite Database IDs to associate, arrange, store, retrieve, compare, and manipulate player profiles containing data and analytics (unique team and player Identity (ID) Number Definition).

FIG. 7 is a Flowchart of Database Arrays, Lists, Sets, and Trees supporting NBA Team Search for Players According to Contextual Attributes in FIG. 6 (Direction 1: Team search for Players)

FIG. 8 is a schematic diagram showing a User Interface Screenshot for NBA Team Search for Players

FIG. 9 is a Flowchart of Database Arrays, Lists, Sets, and Trees supporting NBA Player Search for Teams According to Contextual Attributes in FIG. 6 (Direction 2: Player search for Teams)

FIG. 10 is a schematic diagram showing a User Interface Screenshot for NBA Player Search for Teams

FIG. 11 is a Flowchart of Database Arrays, Lists, Sets, and Trees supporting NBA Player Mobile Device SMS/Text Messaging Notifications and Data Uploads from Third Party Wearable Devices

FIG. 12 is a schematic diagram showing a User Interface Screenshot for NBA Player Mobile Device SMS/Text Messaging Notifications and Data Uploads from Third Party Wearable Devices

All publications, patents, and patent applications cited herein are hereby incorporated by reference in their entirety for all purposes.

### DETAILED DESCRIPTION OF THE PREFERRED EMBODIMENTS

The following presents a detailed description of a preferred embodiment (as well as some alternative embodiments) of the present invention. However, it should be apparent to one skilled in the art that the described embodiment may be modified in form to be optimized for a wide variety of situations.

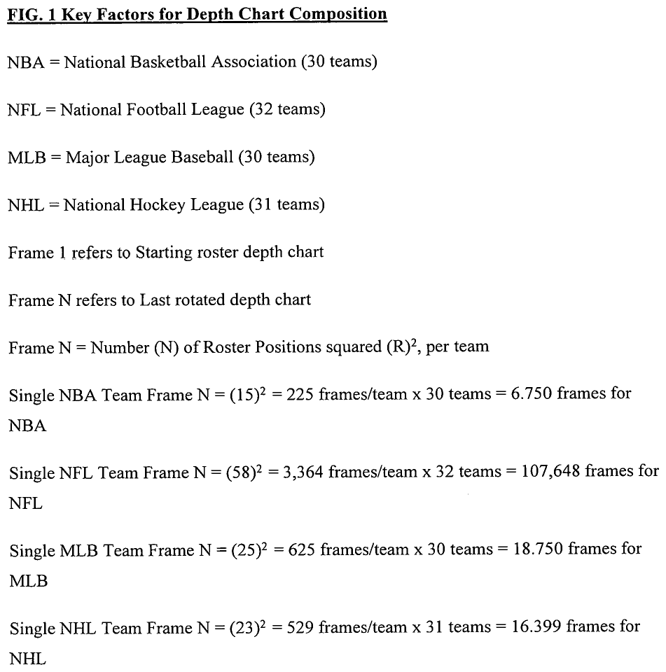

With reference first to FIG. 1, depicted is a summary definitional chart defining Key Factors for Depth Chart Composition. The first two line items define database row and column matrix structure as Frame 1 (starting Roster Depth Chart, accounting for a team's starting lineup) and Frame N (last rotated Roster Depth Chart, accounting for a team's last ‘N’ rotational combination of substituted players) respectively. The value of ‘N’ roster combinations is determined by squaring the team's number of Roster positions (R) to arrive at R².

The next 4 line items of FIG. 1 define abbreviated nomenclature for National Basketball Association (NBA, for which there are 30 teams, 15 players to a team roster), National Football League (NFL, for which there are 32 teams, 58 players to a team roster), Major League Baseball (MLB, for which there are 30 teams, 25 players to a team roster), and National Hockey League (NHL, for which there are 31 teams, 23 players to a team roster).

For purposes of scaling and caching in temporary storage (for increased speed of subsequent retrieval during application data manipulation) the maximum number matrixed database frames, FIG. 1 calculates Frame N for NBA (6,750 frames), NFL (107,648 frames), MLB (18,750 frames), and NHL (16,399 frames).

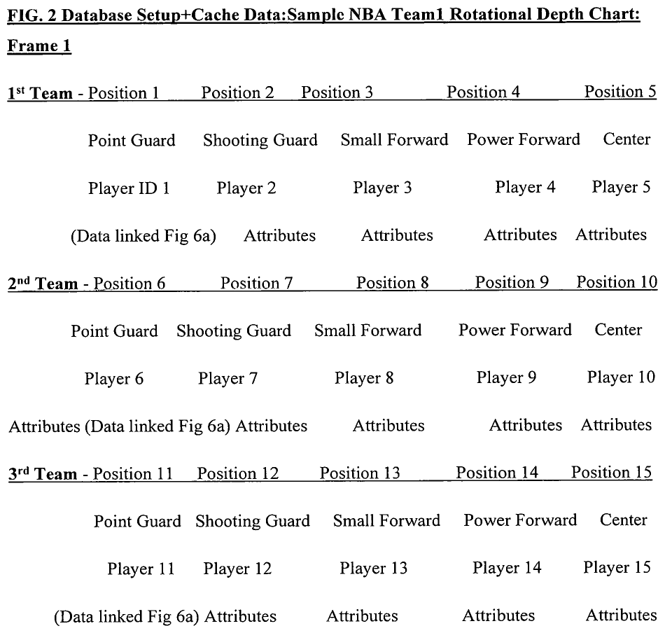

Next, referring to FIG. 2, shown is a schematic diagram depicting sample NBA team's Frame 1 of a database row and column matrix setup and cached data. Database columns represent player positions, and database rows represent depth chart lineups. Note that for the sample NBA team database layout, a roster consists of 15 total players divided into 5 slots (consisting of 15 numbered positions for Point Guard, Shooting Guard, Small Forward, Power Forward, and Center) across 3 lineups.

Thus, the database matrix consists of 5 slotted columns×3 lineup rows=15 slots to house data arrays, lists, and sets. Each lineup row is ordered as a depth chart (players are assigned a fixed identity number 1 through 15 consecutively, indicating both position and roster rank). Each row reflects a matched set of players reflecting a starting lineup, 2^{nd} team, 3^{rd} team.

Point Guard is mapped in the database as player positions 1, 6, and 11, Shooting Guard is mapped in the database as positions 2, 7, and 12, Small Forward is mapped in the database as player positions 3, 8, and 13, Power Forward is mapped in the database as player positions 4, 9, and 14, and Center is mapped in the database as player positions 5, 10, and 15.
Alternatively, Player ID 1=first team Point Guard, Player ID 2=first team Shooting Guard, Player ID 3=first team Small Forward, Player ID 4=first team Power Forward, Player ID 5=first team Center, Player ID 6=second team Point Guard, Player ID 7=second team Shooting Guard, Player ID 8=second team Small Forward, Player ID 9=second team Power Forward, Player ID 10=second team Center, Player ID 11=third team Point Guard, Player ID 12=third team Shooting Guard, Player ID 13=third team Small Forward, Player ID 14=third team Power Forward, Player ID 15=third team Center.

### Allocating Database Locations for Frame 1 by Row and Column:

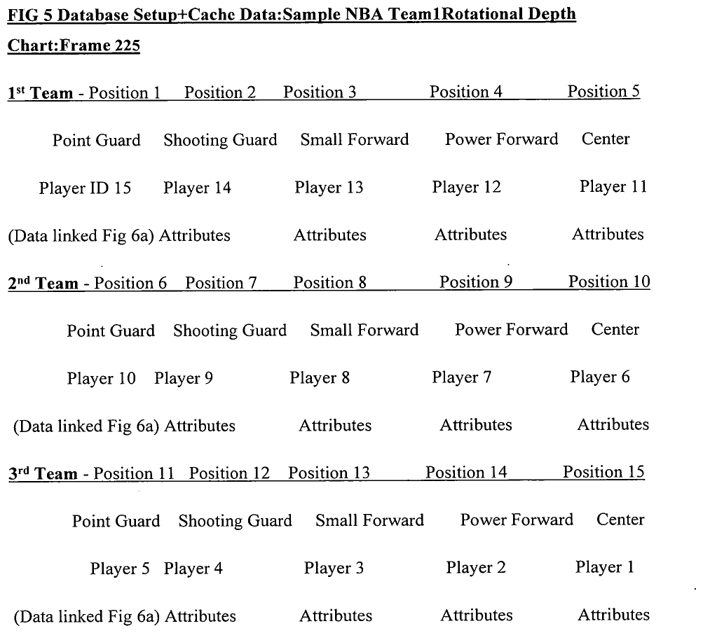

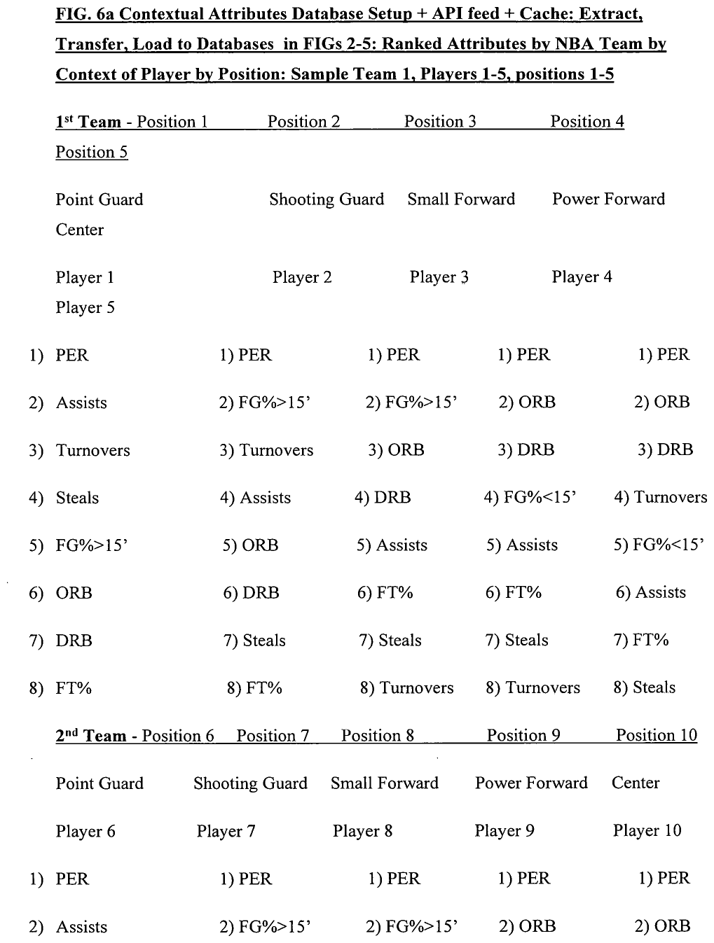

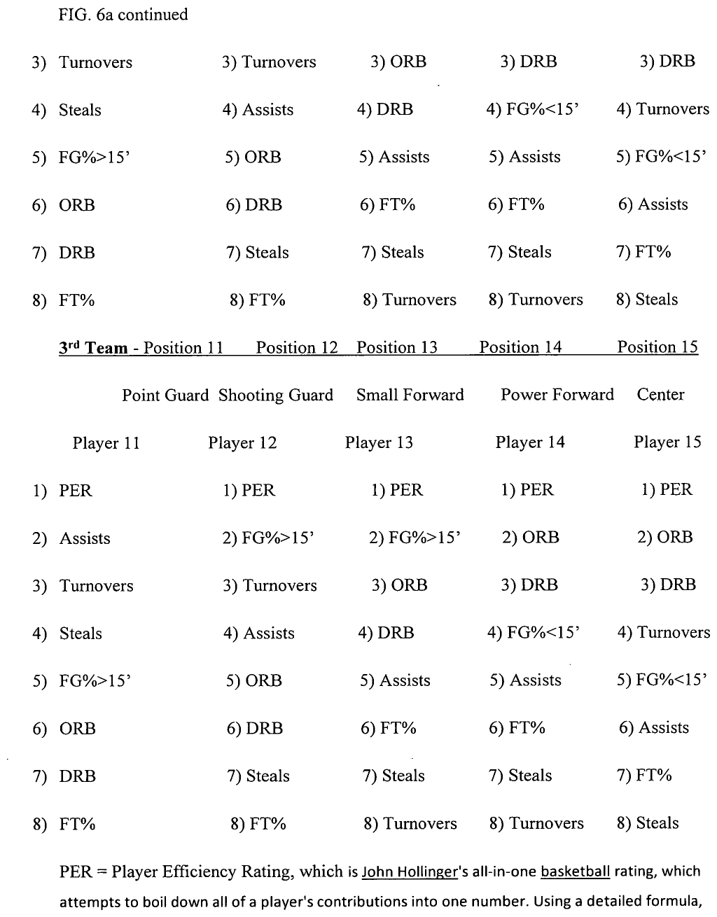

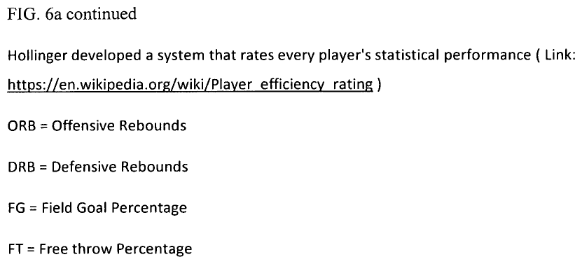

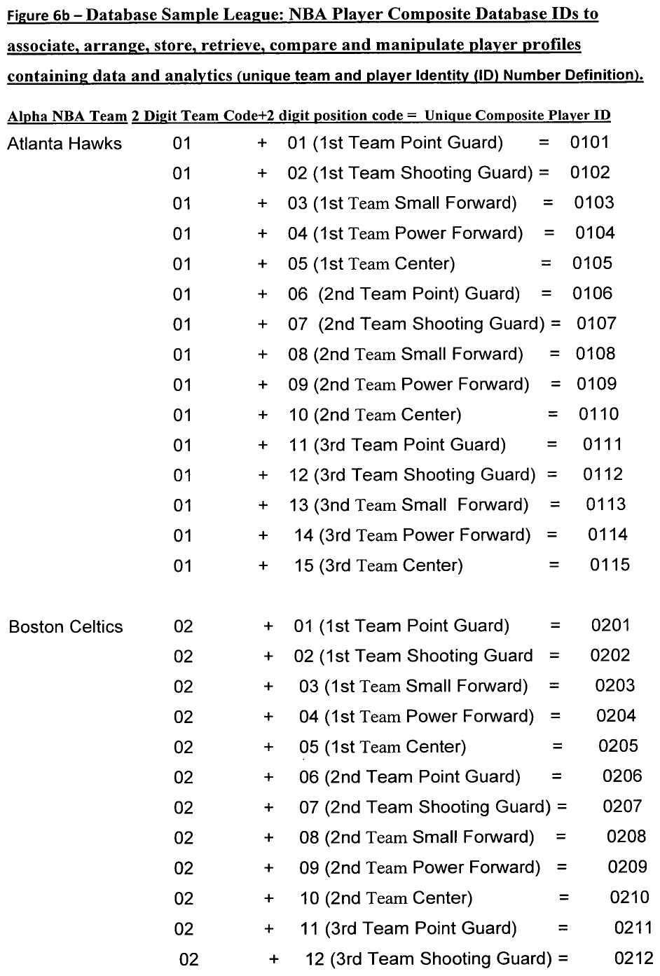

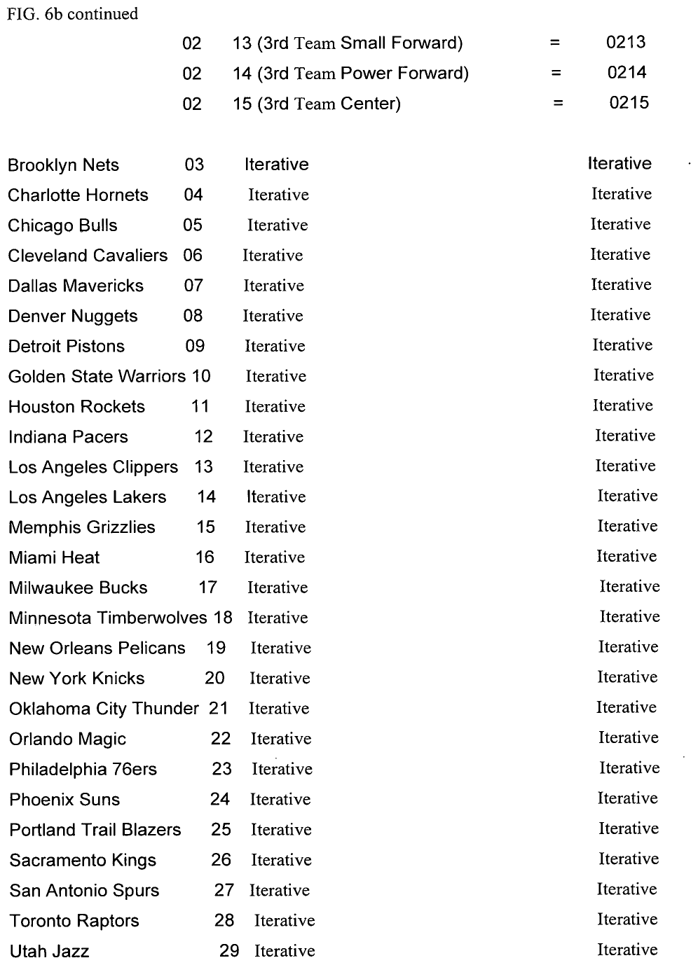

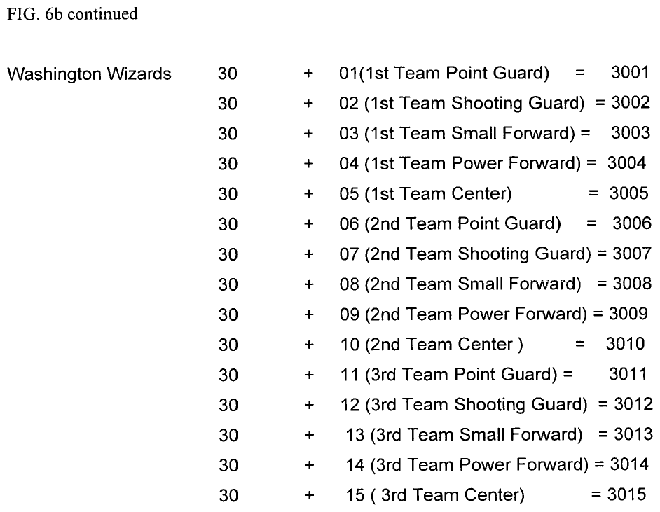

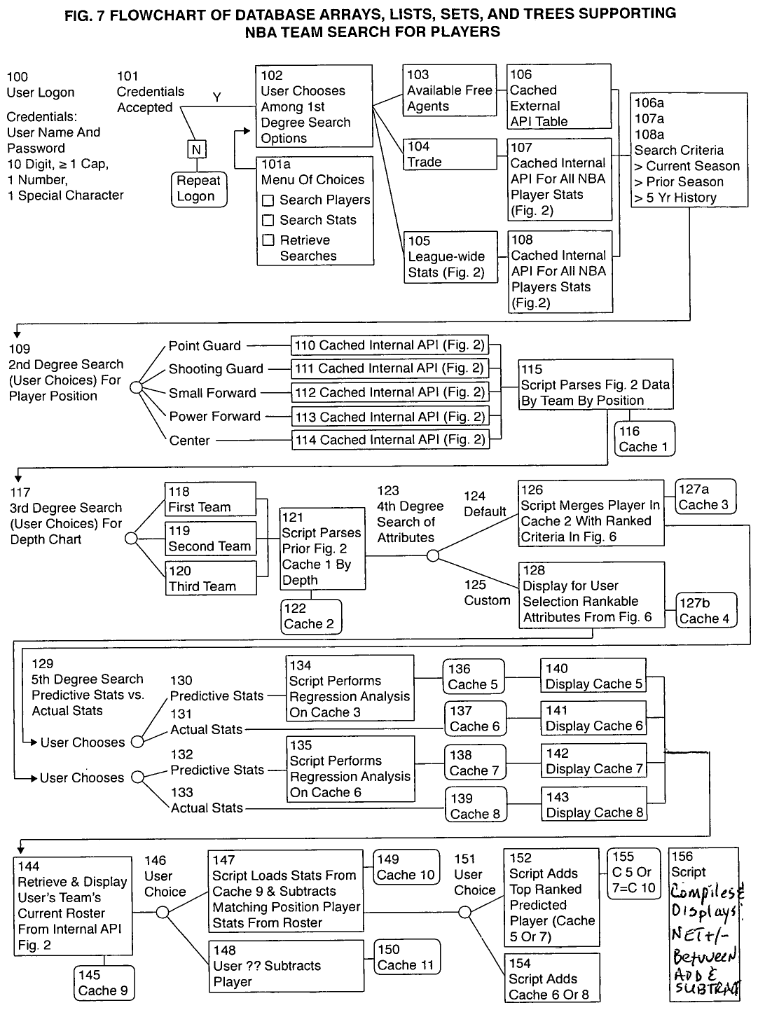

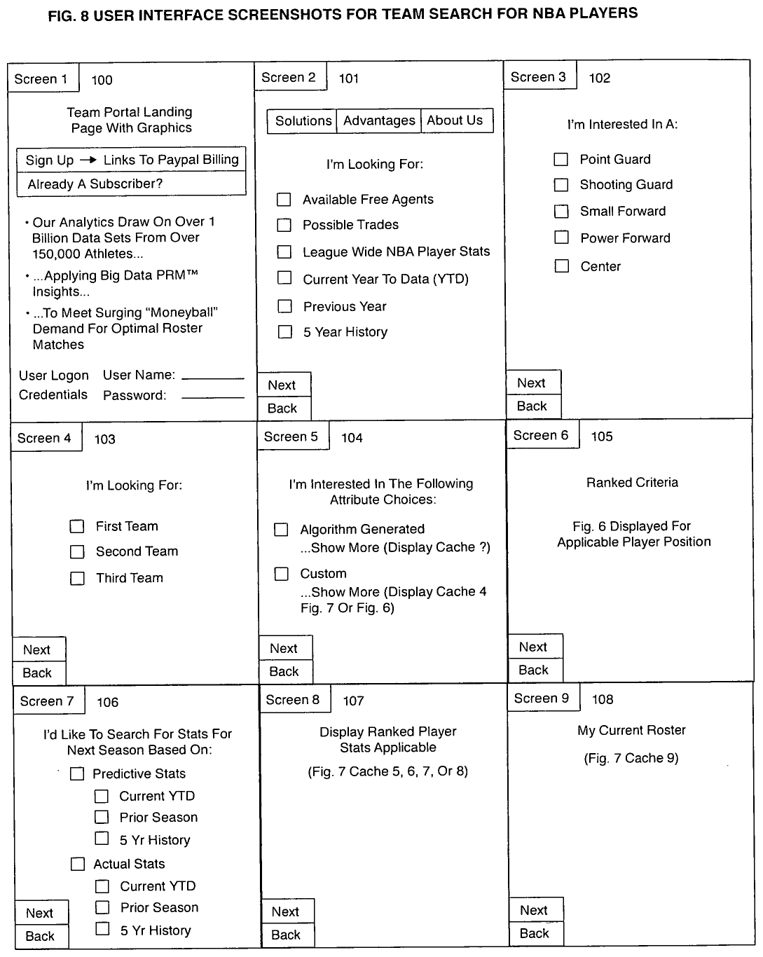

Note that in the data array of each row column intersect (“cell”), data Attributes are retrieved & stored via internal application programmer interface (API) detailed in FIG. 6
Row 1/Column 1=First team Point Guard, Position 1, Player ID 1
Row 1/Column 2=First team Shooting Guard, Position 2, Player ID 2
Row 1/Column 3=First team Small Forward, Position 3, Player ID 3
Row 1/Column 4=First team Power Forward, Position 4, Player ID 4
Row 1/Column 5=First team Center, Position 5, Player ID 5
Row 2/Column 1=Second team Point Guard, Position 6, Player ID 6
Row 2/Column 2=Second team Shooting Guard, Position 7, Player ID 7
Row 2/Column 3=Second team Small Forward, Position 8, Player ID 8
Row 2/Column 4=Second team Power Forward, Position 9, Player ID 9
Row 2/Column 5=Second team Center, Position 10, Player ID 10
Row 3/Column 1=Third team Point Guard, Position 11, Player ID 11
Row 3/Column 2=Third team Shooting Guard, Position 12, Player ID 12
Row 3/Column 3=Third team Small Forward, Position 13, Player ID 13
Row 3/Column 4=Third team Power Forward, Position 14, Player ID 14
Row 3/Column 5=Third team Center, Position 15, Player ID 15

### Alternate 1: Viewing Database Locations for Frame 1 by First+Second+Third Team:

Note that in the data array of each row column intersect (“cell”), data Attributes are retrieved & stored via internal application programmer interface (API) detailed in FIG. 6

### First Team

In Frame 1, note that row 1 consists of a starting lineup of Point Guard (Player ID 1 in position 1, row 1. Column 1), Shooting Guard (player ID 2 in position 2, row 1, column 2), Small Forward (Player ID 3 in position 3, row 1, column 3), Power Forward (Player ID 4 in position 4, row 1 column 4), and Center (Player ID 5 in position 5, row 1, column 5).

### Second Team

In row 2, the second team lineup consists of Point Guard (Player ID 6 in position 6, row 2. Column 1), Shooting Guard (player ID 7 in position 7, row 2, column 2), Small Forward (Player ID 8 in position 8, row 2, column 3), Power Forward (Player ID 9 in position 9, row 2 column 4), and Center (Player ID 10 in position 10, row 2, column 5).

### Third Team

In row 3, the third team lineup consists of Point Guard (Player ID 11 in position 11, row 3. Column 1), Shooting Guard (player ID 12 in position 12, row 3, column 2), Small Forward (Player ID 13 in position 13, row 3, column 3), Power Forward (Player ID 14 in position 14, row 3 column 4), and Center (Player ID 15 in position 15, row 3, column 5).

### Alternate 2: Viewing Database Locations for Frame 1 by Player Position:

Note that in the data array of each row column intersect (“cell”), data Attributes are retrieved and stored via internal application programmer interface (API) detailed in FIG. 6

### Point Guards

Overlaying row and column slots, first team Point Guard is mapped in the database as row 1, column 1, position 1 (composite location=1/1/1); second team Point Guard is mapped in the database as row 2, column 1, position 6 (composite location=2/1/6); third team Point Guard is mapped in the database as row 3, column 1, position 11 (composite location=3/1/11).

### Shooting Guards

Overlaying row and column slots, first team Shooting Guard is mapped in the database as row 1, column 2, position 2 (composite location=1/2/2); second team Shooting Guard is mapped in the database as row 2, column 2, position 7 (composite location=2/2/7); third team Shooting Guard is mapped in the database as row 3, column 2, position 12 (composite location=3/2/12).

### Small Forward

Overlaying row and column slots, first team Small Forward is mapped in the database as row 1, column 3, position 3 (composite location=1/3/3); second team Small Forward is mapped in the database as row 2, column 3, position 8 (composite location=2/3/8); third team Small Forward is mapped in the database as row 3, column 3, position 13 (composite location=3/3/13).

### Power Forward

Overlaying row and column slots, first team Power Forward is mapped in the database as row 1, column 4, position 4 (composite location=1/4/4); second team Power Forward is mapped in the database as row 2, column 4, position 9 (composite location=2/4/9); third team Power Forward is mapped in the database as row 3, column 4, position 14 (composite location=3/4/14).

### Center

Overlaying row and column slots, first team Center is mapped in the database as row 1, column 5, position 5 (composite location=1/5/5); second team Center is mapped in the database as row 2, column 5, position 10 (composite location=2/5/10); third team Center is mapped in the database as row 3, column 5, position 15 (composite location=3/5/15).
Next, FIG. 3 shows a schematic diagram depicting sample NBA team's Frame 2, illustrating the first iterative rotated lineup. Note that in a deployed relational database, highlighted in yellow in FIG. 3 are auto rotated Player ID 6 into the starting lineup position 5 (row 1, column 5) and Player ID 5 into the second team position 6 (row 2, column 1). In FIG. 3 Frame 2, all other Player addresses remain identical to database locations previously assigned in FIG. 2 Frame 1. Note that by pursuing an iterative auto rotation scheme where the Player IDs remain fixed as they are rotated into fixed database addresses (by row/column/position number), the present invention achieves a traceable full cycling of each Player in every possible, finite combination of roster positions and lineups. A visualization of highlighted changes is below:
Row 1/Column 1=First team Point Guard, Position 1, Player ID 1
Row 1/Column 2=First team Shooting Guard, Position 2, Player ID 2
Row 1/Column 3=First team Small Forward, Position 3, Player ID 3
Row 1/Column 4=First team Power Forward, Position 4, Player ID 4
Row 1/Column 5=First team Center, Position 5, Player ID 6
Row 2/Column 1=Second team Point Guard, Position 6, Player ID 5
Row 2/Column 2=Second team Shooting Guard, Position 7, Player ID 7
Row 2/Column 3=Second team Small Forward, Position 8, Player ID 8
Row 2/Column 4=Second team Power Forward, Position 9, Player ID 9
Row 2/Column 5=Second team Center, Position 10, Player ID 10
Row 3/Column 1=Third team Point Guard, Position 11, Player ID 11
Row 3/Column 2=Third team Shooting Guard, Position 12, Player ID 12
Row 3/Column 3=Third team Small Forward, Position 13, Player ID 13
Row 3/Column 4=Third team Power Forward, Position 14, Player ID 14
Row 3/Column 5=Third team Center, Position 15, Player ID 15

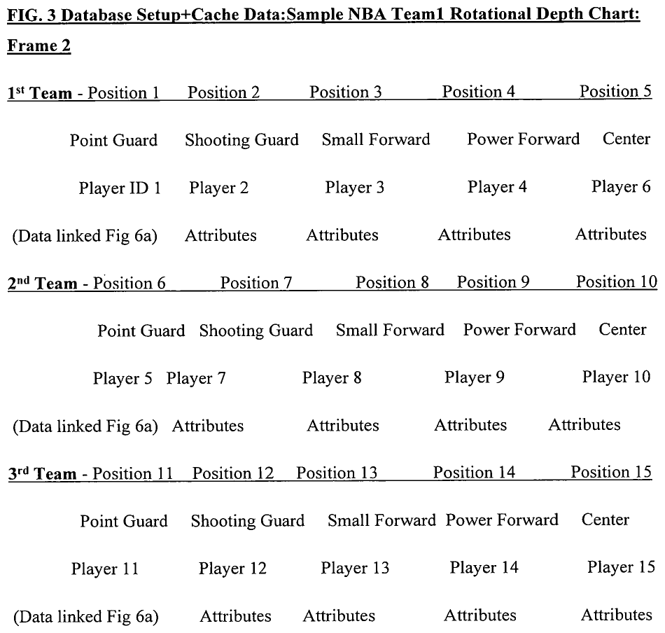

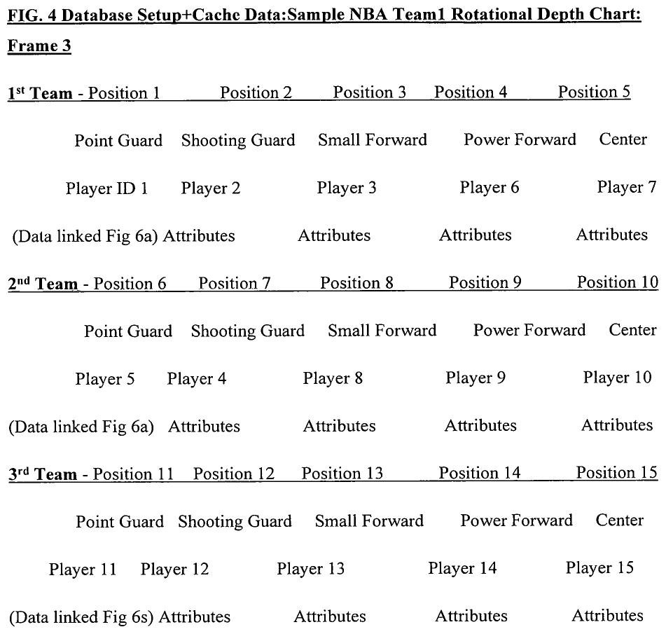

Next, FIG. 4 shows a schematic diagram depicting sample NBA team's Frame 3, illustrating the 2^{nd} iterative rotated lineup. Note that in a deployed relational database, highlighted in yellow in FIG. 4 are rotated Player ID 7 into the starting lineup position 5 (row 1, column 5), remaining in the starting lineup is Player ID 6 with a slot rotation to position 4 (row 1, column 4), while Player ID 4 is auto rotated to second team position 7 (row 2, column 2). In FIG. 4 Frame 3, all other Player addresses remain identical to database locations previously assigned in FIG. 3 Frame 2. Note that by pursuing an iterative rotation scheme where the Player IDs remain fixed as they are rotated into fixed database addresses (by row/column/position number), the present invention achieves a traceable full cycling of each Player in every possible, finite combination of roster positions and lineups. Visualization of highlighted changes is below:

Row 1/Column 1=First team Point Guard, Position 1, Player ID 1
Row 1/Column 2=First team Shooting Guard, Position 2, Player ID 2
Row 1/Column 3=First team Small Forward, Position 3, Player ID 3
Row 1/Column 4=First team Power Forward, Position 4, Player ID 6
Row 1/Column 5=First team Center, Position 5, Player ID 7
Row 2/Column 1=Second team Point Guard, Position 6, Player ID 5
Row 2/Column 2=Second team Shooting Guard, Position 7, Player ID 4
Row 2/Column 3=Second team Small Forward, Position 8, Player ID 8
Row 2/Column 4=Second team Power Forward, Position 9, Player ID 9
Row 2/Column 5=Second team Center, Position 10, Player ID 10
Row 3/Column 1=Third team Point Guard, Position 11, Player ID 11
Row 3/Column 2=Third team Shooting Guard, Position 12, Player ID 12
Row 3/Column 3=Third team Small Forward, Position 13, Player ID 13
Row 3/Column 4=Third team Power Forward, Position 14, Player ID 14
Row 3/Column 5=Third team Center, Position 15, Player ID 15

Next, FIG. 5 shows a schematic diagram depicting sample NBA team's Frame 225, illustrating the 225^{th} iterative rotated lineup. Note that in a deployed relational database, highlighted in yellow in FIG. 5 all slot positions are rotated in comparison to the starting roster (FIG. 2, Frame 1). Note that by pursuing an iterative rotation scheme where the Player IDs remain fixed as they are rotated into fixed database addresses (by row/column/position number), the present invention achieves a traceable full cycling of each Player in every possible, finite combination of roster positions and lineups. Visualization of changes is below:

Row 1/Column 1=First team Point Guard, Position 1, Player ID 15
Row 1/Column 2=First team Shooting Guard, Position 2, Player ID 14
Row 1/Column 3=First team Small Forward, Position 3, Player ID 13
Row 1/Column 4=First team Power Forward, Position 4, Player ID 12
Row 1/Column 5=First team Center, Position 5, Player ID 11
Row 2/Column 1=Second team Point Guard, Position 6, Player ID 10
Row 2/Column 2=Second team Shooting Guard, Position 7, Player ID 9
Row 2/Column 3=Second team Small Forward, Position 8, Player ID 8
Row 2/Column 4=Second team Power Forward, Position 9, Player ID 7
Row 2/Column 5=Second team Center, Position 10, Player ID 6
Row 3/Column 1=Third team Point Guard, Position 11, Player ID 5
Row 3/Column 2=Third team Shooting Guard, Position 12, Player ID 4
Row 3/Column 3=Third team Small Forward, Position 13, Player ID 3
Row 3/Column 4=Third team Power Forward, Position 14, Player ID 2
Row 3/Column 5=Third team Center, Position 15, Player ID 1

Next, FIG. 6a depicts a schematic diagram of Contextual Attributes Database Setup+API feed+Cache: Extract, Transfer, Load to Databases in FIGS. 2-5: Ranked Attributes by NBA Team by Context of Player by Position: Sample Team 1, Players 1-5, positions 1-5. Note that in the data array of each row column intersect (“cell”), data Attributes are retrieved and stored via internal application programmer interface (API) delivering cached data to database sector in FIG. 2. By player position, pre-sorted performance attribute data in 3^{rd} party database is delivered to FIG. 6 database via API.

FIG. 6b, depicts a schematic diagram of a Database Sample League: NBA Player Composite Database IDs to associate, arrange, store, search, fetch, retrieve, compare, and manipulate player profiles containing data and analytics (unique team and player Identity (ID) Number Definition). Regarding database layout, starting with the NBA and similarly prepared for NFL, MLB, and NHL, after player data is imported to the present invention database from a 3^{rd} party application programmer interface (API), the present invention normalizes said data beginning with associating the API supplied Player Name (located in the 3^{rd} party API imported player profile) and nominal Player ID (located in the API data stream) to the present invention's unique composite player ID. Below is a further detailed explanation of the present invention's unique team and player Identity (ID) Number Definition. The purpose of the present invention's unique player ID is to associate and track player stats by their team+position+order on roster depth charts to enable “apple-apple” (i.e., same player position, same player depth on roster depth chart) comparisons and substitutions of player statistics between teams.

### Methodology

Note that FIG. 6a is intended to be a team level database layout and raw data backend database landing spot for the 3^{rd} party API, not a viewable screen for system users. FIG. 2 serves as the 1, 2, 3, 4, or 5 year historical baseline (viewable by users) from which predictive analytics are developed, viewable by system users)
In FIG. 6a, the raw data incoming from the 3^{rd} party API is normalized ordered/ranked by player positon (Point Guard, Shooting Guard, Small Forward, Power Forward, and Center), with a database script assigning each position a different ranked order of 1 through 8 for statistical categories PER, Points/Game, Assists, Turnovers, Steals, ORB and DRB and FT %. In example, the Atlanta Hawks team has 15 total players comprised of 1st string unit of 5 players (position number 01) Point Guard, position number 02) Shooting Guard, position number 03) Small Forward, position number 04) Power Forward, and position number 05) Center), 2nd string unit of 5 players (position number 06) Point Guard, position number 07) Shooting Guard, position number 08) Small Forward, position number 09) Power Forward, and position number 10) Center), and 3rd string unit of 5 players (position number 11) Point Guard, position number 12) Shooting Guard, position number 13) Small Forward, position number 14) Power Forward, and position number 15) Center).
By position specific ranking, per FIG. 6a, per game average stats (incoming from a 3^{rd} party API) for Point Guards are to be ranked in order of attribute importance as 1) PER, 2) Assists, 3) Turnovers, 4) Steals, 5) Points, 6) ORB 7) DRB, 8) FT %. For Shooting Guards, the stats are to be ranked in order 1) PER, 2) Points, 3) Turnovers, 4) Assists, 5) ORB, 6) DRB, 7) Steals, 8) FT %. For Small Forwards, the stats are to be ranked in order 1) PER, 2) Points, 3) ORB, 4) DRB, 5) Assists, 6) FT %, 7) Steals, 8) Turnovers. For Power Forwards, the stats are to be ranked in order 1) PER, 2) ORB, 3) DRB, 4) Points, 5) Assists, 6) FT %, 7) Steals, 8) Turnovers. For Centers, the stats are to be ranked in order 1) PER, 2) ORB, 3) DRB, 4) Turnovers, 5) Points, 6) Assists, 7) FT % 8) Steals.
Again, FIG. 6a serves as a back end platform workspace to receive raw data feeds from a 3^{rd} party party API, rank/order the stats by player position, and Individual players are assigned (by a database script) a unique player ID (comprised of team number incrementing by increasing number linked to alphabetical order. There are 30 teams (team ID 01 through 30) and there are 15 players per team (position numbers 01 through 15). By way of example, the Atlanta Hawks of the National Basketball Association, hereafter NBA, (‘A”=01), first string point guard=position 01, thus the composite team/player ID for the Atlanta Hawks 1st string point guard is 0101). Continuing the same example, Atlanta Hawks (‘A”=01), first string shooting guard=position 02, thus the composite team/player ID for the Atlanta Hawks 1st string shooting guard team/player ID is 0102), Atlanta Hawks 1st string small forward team/player ID is 0103, Atlanta Hawks 1st string power forward team/player ID is 0104, and Atlanta Hawks 1st string center team/player ID is 0105,
Continuing the same example, Atlanta Hawks, second string point guard team/player ID=0106, 2nd string shooting guard team/player ID is 0107), 2nd string small forward team/player ID is 0108, 2nd string power forward team/player ID is 0109, and Atlanta Hawks 2nd string center team/player ID is 0110.
Continuing the same example, Atlanta Hawks, third string point guard team/player ID=0111, 3rd string shooting guard team/player ID is 0112), 3rd string small forward team/player ID is 0113, 3rd string power forward team/player ID is 0114, and Atlanta Hawks 3rd string center team/player ID is 0115.
Continuing the example, the next alphabetically listed NBA team is the Boston Celtics (‘B”=02), first string point guard team/player ID=0201, first string shooting guard=position 02, thus the composite team/player ID for the Atlanta Hawks 1st string shooting guard team/player ID is 0202), Atlanta Hawks 1st string small forward team/player ID is 0203, Atlanta Hawks 1st string power forward team/player ID is 0204, and Atlanta Hawks 1st string center team/player ID is 0205,
Continuing the same example, Boston Celtics, second string point guard team/player ID=0206, 2nd string shooting guard team/player ID is 0207), 2nd string small forward team/player ID is 0208, 2nd string power forward team/player ID is 0209, and Atlanta Hawks 2nd string center team/player ID is 0210.
Continuing the same example, Boston Celtics, third string point guard team/player ID=0211, 3rd string shooting guard team/player ID is 0212), 3rd string small forward team/player ID is 0213, 3rd string power forward team/player ID is 0214, and Atlanta Hawks 3rd string center team/player ID is 0215.
Jumping to the last alphabetically listed NBA team, the Washington Wizards (′W″=30), first string point guard team/player ID=3001, first string shooting guard=position 02, thus the composite team/player ID for the Washington Wizards 1st string shooting guard team/player ID is 3002), Washington Wizards 1st string small forward team/player ID is 3003, Washington Wizards 1st string power forward team/player ID is 3004, and Washington Wizards 1st string center team/player ID is 3005,
Continuing the same example, Washington Wizards, second string point guard team/player ID=3006, 2nd string shooting guard team/player ID is 3007), 2nd string small forward team/player ID is 3008, 2nd string power forward team/player ID is 3009, and Atlanta Hawks 2nd string center team/player ID is 3010.
Continuing the same example, Washington Wizards, third string point guard team/player ID=3011, 3rd string shooting guard team/player ID is 3012), 3rd string small forward team/player ID is 3013, 3rd string power forward team/player ID is 3014, and Washington Wizards 3rd string center team/player ID is 3015.
Then, via a database script, the ranked/ordered attributes/stats are merged into the front-end user viewable Team Roster Profile, comprised of stats for individual Player Profiles associated with each team (as described in FIG. 2).

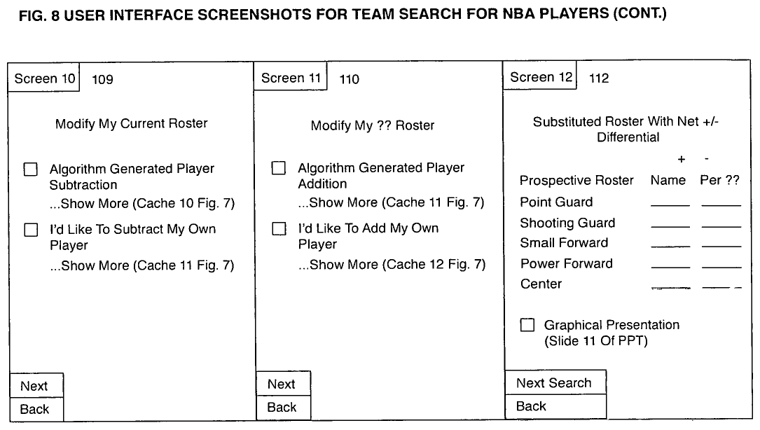

Referring to FIG. 7, which is a Flowchart of Database Arrays, Lists, Sets, and Trees supporting NBA Team Search for Players According to Contextual Attributes in FIG. 6a (Direction 1: Team search for Players), online user logs on 100, and after credentials are confirmed and accepted by the computer server 101, user searches summary menu 101a, choosing among options for searching players, statistics, and previously saved searches. Choosing a first-degree search for players 102, user narrows the search category to either free agents 103, players available for trade 104, and league wide statistics 105. If user selects to search available free agents, and user then selects data periods 106a from either current season to date, prior season, or 5 year history, a list of players and matching performance statistics (FIG. 6) is displayed via a cached external application programmer interface (API) connection 106. As an option, if user selects to search players available for trade, and user then selects data periods 107a from either current season to date, prior season, or 5 year history, a list of players and matching performance statistics (FIG. 6a) is displayed via a cached internal API connection 107. Alternatively, if user selects to view league wide statistics, and user then selects data periods 108a from either current season to date, prior season, or 5 year history, a list of players and matching performance statistics (FIG. 6) is displayed via a cached internal API connection 108.

After executing step 106 or 107 or 108, user arrives at second-degree search option for player position 109. User selects among player position options for Point Guard 110, Shooting Guard 111, Small Forward 112, Power Forward 113, or Center 114, with each attendant selection resulting in server retrieval of cached matching, period specific, player statistics (formatted per FIG. 2) from internal API. An internal script 115 then parses formatted data by team and by players and saves result in cache #1, step 116.

User arrives at third-degree search option for depth chart elections for first team 118, second team 119, or third team 120. Upon user selection, server retrieves previous parse data records from cache #1, and server performs additional parsing of data, sorting alphabetically within depth 121, creating cache #2, as step 122.

User arrives at fourth-degree search option 123 for player statistical performance data file referred to as “attributes” created by manipulating data in cache #2. User chooses between default pre-set attribute criteria from database (FIG. 6) step 124 or custom user configurable ranked attributes (re-ranking attributes in FIG. 6), step 125. If user chooses the default option, server script merges 126 data from cache #2 with ranked criteria in FIG. 6a, to produce an attributes data file of player position specific, period specific, statistics ranked and formatted per categories in FIG. 6, with server storing produced data file in cache #3 as step 127a. If user chooses the custom option, server displays for user ranking attributes form FIG. 6, with the resulting data file being saved in cache #4, step 127b.

User arrives at fifth-degree search option 129 to choose between;

1) predictive statistical analysis 130, whereby a script performs regression analysis 134 using default attributes (i.e., player position specific, period specific, statistics ranked and formatted per categories in FIG. 6) retrieved from cache #3 in step 127a, with the new regression data file saved in cache #5, as step 136, data contents of cache #5 displayed in step 140, noting that the script generated regression is produced in the context of roster position depth and is controlled for independent variables player age, and pooled historical age-driven factors for injury, minutes played, and load management, or
2) non-predictive statistical analysis 131 based on data retrieved from cache #2, with the new non-regression data file saved in cache #7 as step 138—data contents of cache #7 displayed in step 142, or
3) predictive statistical analysis 132, whereby a script performs regression analysis 135 using default attributes (i.e., player position specific, period specific, statistics ranked and formatted per categories in FIG. 6), retrieved from cache #3 in step 127a, with the new regression data file saved in cache #6, as step 137, data contents of cache #6 displayed in step 141, noting that the script generated regression is produced in the context of roster position depth and is controlled for independent variables player age, and pooled historical age-driven factors for injury, minutes played, and load management, or
4) non-predictive statistical analysis 133 based on data retrieved from cache #2, with the new non-regression data file saved in cache #8 as step 139, data contents of cache #8 displayed in step 143.
While teams routinely take out insurance policies against future player total disability, insurance models forecast risks of partial/total disability rather than isolating the predicted effect of injuries on future production (the latter of which is what the present invention achieves). The present invention creates a forward-looking production model, controlling for age, injury, minutes played, and load management to enable a quantitative evaluation of player age and injury potential, useful in, amongst other purposes, player resume preparation, player recruitment/acquisition, facilitation of player trades, free agent player contract negotiations, and contractual player labor pricing. The present invention approach is similar to athlete injury insurance modelling such as Lloyd's of London (which insures players under guaranteed contracts against injury, determining apriori risks of injury/and resulting partial+total disability, setting policy premiums based on historical pools of correlated age, player position, and categorized injuries).

By user pressing a “Next Screen” button at conclusion of steps 144, 141, 142, or 143, in step 144 “Roster Substitution”, server retrieves and displays user's team's current roster player statistics from internal API in FIG. 2, and server saves retrieved data as cache #9, as step 145. In step 146, user chooses between default server algorithm selection and subtraction of current roster matched position player's statistics from roster, step 147, or custom user selection and subtraction of current roster matched position player's statistics from roster, step 148. If user selects default step 147, result is stored in cache #10, step 149. If user selects custom step 148, the result stored in cache #11, as step 150. User then chooses 151 between default server algorithm selection and addition (of previous user selected Cache #5 or Cache #7) matched position player's statistics to roster, step 152, or custom user selection and addition (of previous user selected Cache #6 or Cache #8)) matched position player's statistics to roster, step 153. If user selects default step 152, result is stored in cache #12, step 155. If user selects custom, the result stored in cache #11, as step 154.

After conclusion of step 155, user presses “Next Screen” button and then in step 156, server script calculates and displays net positive gain or net negative loss for each statistical category between he added and subtracted players, and then server displays the net statistical difference between substituted players in the context of actual “before” and prospective “after” rosters.

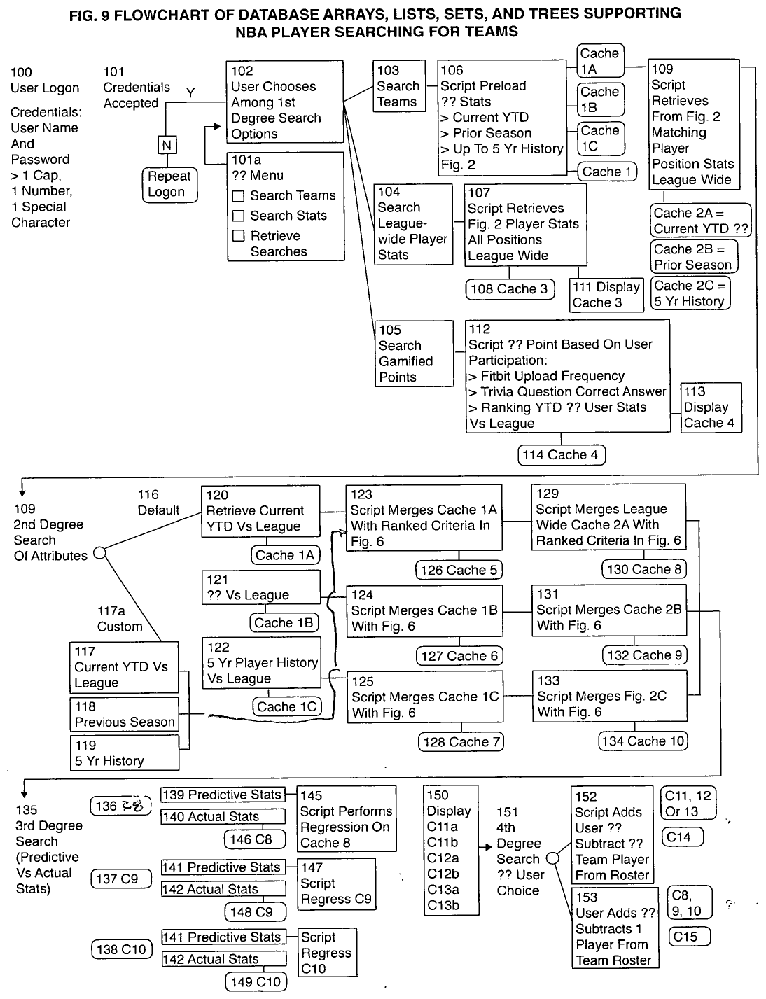

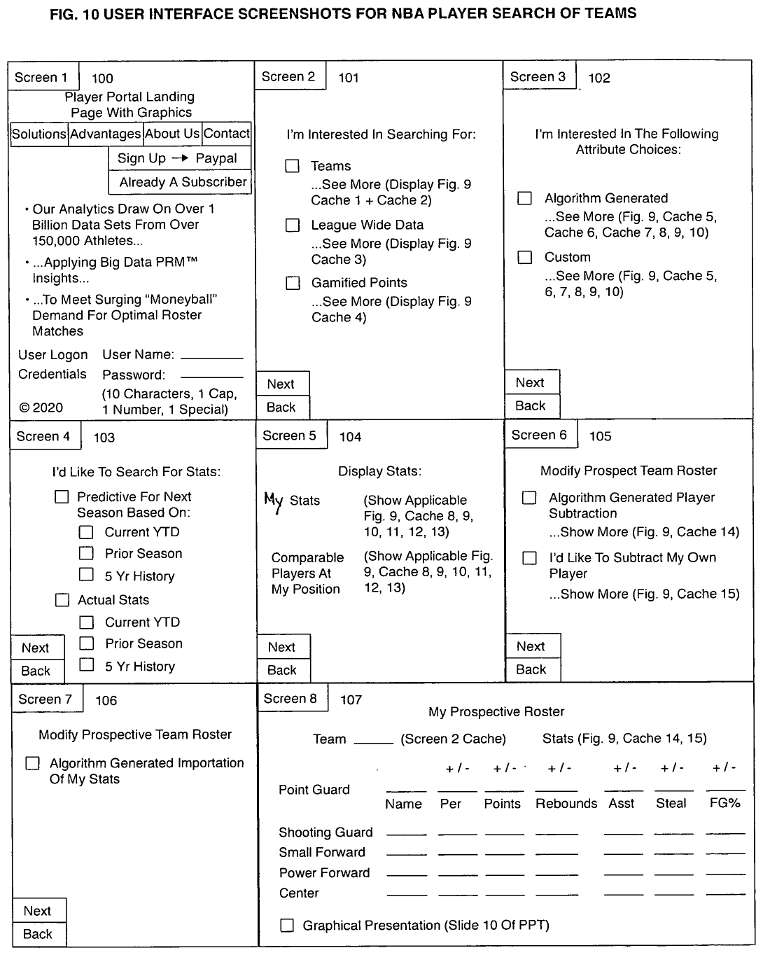

In FIG. 8, a schematic diagram shows a User Interface Screenshot for NBA Team Search for Players.

Screen 1 step 100

In step 100 on Screen 1, user logs on to application with credentials, which after server confirmation, server displays Screen 2.

### Screen 2, Step 101

(Note: Instruction step numbers overlaid from FIG. 7). In Screen 2, user searches summary menu 101, choosing among options for searching players, statistics, and previously saved searches. Choosing a first-degree search for players 102, user narrows the search category to either free agents 103, players available for trade 104, and league wide statistics 105. If user selects to search available free agents, and user then selects data periods 106a from either current season to date, prior season, or 5 year history, a list of players and matching performance statistics (FIG. 6a) is displayed via a cached external application programmer interface (API) connection 106. As an option, if user selects to search players available for trade, and user then selects data periods 107a from either current season to date, prior season, or 5 year history, a list of players and matching performance statistics (FIG. 6a) is displayed via a cached internal API connection 107. Alternatively, if user selects to view league wide statistics, and user then selects data periods 108a from either current season to date, prior season, or 5 year history, a list of players and matching performance statistics (FIG. 6) is displayed via a cached internal API connection 108.

### Screen 3, Step 102

(Note: Instruction step numbers overlaid from FIG. 7). After executing step 106 or 107 or 108, on Screen 3, user arrives at second-degree search option for player position 109. User selects among player position options for Point Guard 110, Shooting Guard 111, Small Forward 112, Power Forward 113, or Center 114, with each attendant selection resulting in server retrieval of cached matching, period specific, player statistics (formatted per FIG. 2) from internal API. An internal script 115 then parses formatted data by team and by players and saves result in cache #1, step 116.

### Screen 4, Step 103

(Note: Instruction step numbers overlaid from FIG. 7). In Screen 4, user arrives at third-degree search option for depth chart elections for first team 118, second team 119, or third team 120. Upon user selection, server retrieves previous parse data records from cache #1, and server performs additional parsing of data, sorting alphabetically within depth 121, creating cache #2, as step 122.

### Screen 5, Step 104

(Note: Instruction step numbers overlaid from FIG. 7). In Screen 5, user arrives at fourth-degree search option 123 for player statistical performance data file referred to as “attributes” created by manipulating data in cache #2. User chooses between default pre-set attribute criteria from database (FIG. 6) step 124 or custom user configurable ranked attributes (re-ranking attributes in FIG. 6), step 125. If user chooses the default option, server script merges 126 data from cache #2 with ranked criteria in FIG. 6, to produce an attributes data file of player position specific, period specific, statistics ranked and formatted per categories in FIG. 6, with server storing produced data file in cache #3 as step 127a. If user chooses the custom option, server displays for user ranking attributes form FIG. 6, with the resulting data file being saved in cache #4, step 127b.

### Screen 6, Step 105

Display of FIG. 6 displayed ranked criteria applicable player position

### Screen 7, Step 106

(Note: Instruction step numbers overlaid from FIG. 7). User arrives at fifth-degree search option 129 to choose between;

1) predictive statistical analysis 130, whereby a script performs regression analysis 134 using default attributes (i.e., player position specific, period specific, statistics ranked and formatted per categories in FIG. 6a) retrieved from cache #3 in step 127a, with the new regression data file saved in cache #5, as step 136, data contents of cache #5 displayed in step 140, or
2) non-predictive statistical analysis 131 based on data retrieved from cache #2, with the new non-regression data file saved in cache #7 as step 138, data contents of cache #7 displayed in step 142, or
3) predictive statistical analysis 132, whereby a script performs regression analysis 135 using default attributes (i.e., player position specific, period specific, statistics ranked and formatted per categories in FIG. 6), retrieved from cache #3 in step 127a, with the new regression data file saved in cache #6, as step 137, data contents of cache #6 displayed in step 141 or
4) non-predictive statistical analysis 133 based on data retrieved from cache #2, with the new non-regression data file saved in cache #8 as step 139, data contents of cache #8 displayed in step 143.

### Screen 8, Step 107

Display of FIG. 7 applicable Cache 5, 6, 7, 8

### Screen 9, Step 108

Display of FIG. 7 applicable Cache 9

### Screen 10, Step 109

(Note: Instruction step numbers overlaid from FIG. 7). By user pressing a “Next Screen” button at bottom of Screen 9 at conclusion of steps 144, 141, 142, or 143, in step 144 “Roster Substitution”, server retrieves and displays user's team's current roster player statistics from internal API in FIG. 2, and server saves retrieved data as cache #9, as step 145. In step 146, user chooses between default server algorithm selection and subtraction of current roster matched position player's statistics from roster, step 147, or custom user selection and subtraction of current roster matched position player's statistics from roster, step 148. If user selects default step 147, result is stored in cache #10, step 149. If user selects custom step 148, the result stored in cache #11, as step 150.

### Screen 11, Step 110

(Note: Instruction step numbers overlaid from FIG. 7). User then chooses 151 between default server algorithm selection and addition (of previous user selected Cache #5 or Cache #7) matched position player's statistics to roster, step 152, or custom user selection and addition (of previous user selected Cache #6 or Cache #8)) matched position player's statistics to roster, step 153. If user selects default step 152, result is stored in cache #12, step 155. If user selects custom, the result stored in cache #11, as step 154.

### Screen 12, Step 111

(Note: Instruction step numbers overlaid from FIG. 7). After conclusion of step 155, user presses “Next Screen” button and then in step 156, server script calculates and displays net positive gain or net negative loss for each statistical category between he added and subtracted players, and then server displays the net statistical difference between substituted players in the context of actual “before” and prospective “after” rosters.

FIG. 9 is a Flowchart of Database Arrays, Lists, Sets, and Trees supporting NBA Player Search for Teams According to Contextual Attributes in FIG. 6 (Direction 2: Player search for Teams). In step 100, user logs onto website with credentials. After server confirms credentials 101, server retrieves form database and displays a summary menu 101a, where user can choose 102 to search teams 103, search statistics 104, search gamified points 105, or retrieve saved searches.

If user elects to search for teams in step 103, server script pre-loads 106 user's stats (from FIG. 2) and saves into 3 caches a) current year-to-date (YTD) statistics (Cache #1A), b) prior season statistics (Cache #1B), and c) up to 5 year history (Cache #1C). Server script 109 then retrieves from FIG. 2 position and period matched league-wide player stats, saving the result in Cache #2, in step 110.

If user selects to view league wide stats in step 104, server script retrieves form database in FIG. 2 period matched stats for all players league-wide, and server saves data in Cache 3 as step 108, and server displays Cache #3 contents as step 111.

If in step 104 user elects to search for period-to-date accumulated gamified points e.g., promotional points generated, tracked, and stored in Cache #4 step 114, and displayed in step 113 by server for user logons, usage, trivia question answers, data uploads, YTD ranking of user's stats vs. league, etc.), server script 112 calculates points based on user participation, stats, etc.

In step 115, server displays user selectable default 116 and custom 117a options for a second-degree search of position and period matched player attributes. If in step 116, user selects default option for server algorithm to select matching player stats, server then retrieves from database previous user selected 106 period specific data from corresponding Cache #1A, 1B, or 1C. Server script then merges user's applicable performance data from Cache 1A, 1B, or 1C ranked attributes format in database from FIG. 6a with server then saving resulting data files Cache 5 (corresponding to merged data from Cache 1A into database from FIG. 6), Cache 6 (corresponding to merged data from Cache 1B into database from FIG. 6), or Cache 7 (corresponding to merged data from Cache 1C into database from FIG. 6). In steps 129a (current year data), 131a (prior year data), and 133a (5 year historical data) server script then merges league-wide period specific data previously stored in Cache #2 with ranked attribute format in FIG. 6, stored in Cache 8a (current year data from Cache 2A) as step 130a, Cache 9a (prior year data from Cache 2B) as step 132a, and Cache 10a (5 year historical data from Cache 2C) as step 134a.

Alternatively, if, in step 117a, user selects the custom option, user selects period, and server retrieves from database user's matching previously saved data from corresponding Cache 1A (current year data), Cache 1B (prior year data), or Cache 1C (5 year history). Server script then merges user's applicable performance data from Cache 1A, 1B, or 1C ranked attributes format in database from FIG. 6a with server then saving resulting data files Cache 5 (corresponding to merged data from Cache 1A into database from FIG. 6a), Cache 6 (corresponding to merged data from Cache 1B into database from FIG. 6), or Cache 7 (corresponding to merged data from Cache 1C into database from FIG. 6). In steps 129b (current year data), 131b (prior year data), and 133b (5 year historical data) server script then merges league-wide period specific data previously stored in Cache #2 with user ranked attribute format in FIG. 6a, stored in Cache 8b (current year data from Cache 2A) as step 130b, Cache 9b (prior year data from Cache 2B) as step 132b, and Cache 10b (5 year historical data from Cache 2C) as step 134b.

User arrives at third-degree search option 135 to choose between current YTD data (steps 1 and 2 below), prior season data (steps 3 and 4 below), and 5 year historical data (steps 5 and 6 below);

1) predictive statistical analysis 139, whereby a script performs regression analysis 139 using default attributes (i.e., player position specific, period specific, statistics ranked and formatted per categories in FIG. 6a) retrieved from cache #8a in step 130a, with the new regression data file saved in cache #11a, as step 145a, data contents of cache #11a displayed in step 150, or
2) non-predictive statistical analysis 140 based on data retrieved from cache #8b, with the new non-regression data file saved in cache #11b as step 145b, data contents of cache #11b displayed in step 150, or
3) predictive statistical analysis 141, whereby a script performs regression analysis 141 using default attributes (i.e., player position specific, period specific, statistics ranked and formatted per categories in FIG. 6), retrieved from cache #9a in step 132, with the new regression data file saved in cache #12a, as step 137, data contents of cache #12a displayed in step 150 or
4) non-predictive statistical analysis 142 based on data retrieved from cache #10a, with the new non-regression data file saved in cache #12b as step 147, data contents of cache #12b displayed in step 150.
5) predictive statistical analysis 143, whereby a script performs regression analysis 148 using default attributes (i.e., player position specific, period specific, statistics ranked and formatted per categories in FIG. 6a), retrieved from cache #10a in step 134, with the new regression data file saved in cache #6, as step 137, data contents of cache #13a displayed in step 150 or
6) non-predictive statistical analysis 144 based on data retrieved from cache #10b, with the new non-regression data file saved in cache #13b as step 149, data contents of cache #13b displayed in step 150.

In step 151, user chooses between 1) default server algorithm selection and subtraction of current roster matched position player's statistics from roster from corresponding user chosen steps 139 (current YTD data), 141 (prior season data) or 143 (5 yr historical data), or 2) custom user selection and subtraction of current roster matched position player's statistics from roster, step 140 (current YTD data), 142 (prior season data), or 144 (5 yr historical data). If user selects default step 139. 141, or 143, result is stored in cache #14, step 154. If user selects custom steps 140, 142, or 144, the result stored in cache #15, as step 155.

User then chooses 156 between default server algorithm selection and addition (of previous user selected Cache #11a or Cache #12a or Cache #13a) matched position player's statistics to roster, step 157, or custom user selection and addition (of previous user selected Cache #11b, or Cache #12b or Cache #13b)) matched position player's statistics to roster, step 158. If user selects default step 152, result is stored in cache #16, step 159. If user selects custom, the result stored in cache #17, as step 160.

In step 161, server script calculates and displays net positive gain or net negative loss for each statistical category between he added and subtracted players, and then server displays the net statistical difference between substituted players in the context of actual “before” and prospective “after” rosters.

FIG. 10 is a schematic diagram showing a User Interface Screenshot for NBA players search for Teams.

### Screen 1 Step 100

In step 100 on Screen 1, user logs on to application with credentials, which after server confirmation, server displays Screen 2.

### Screen 2, Step 101

(Note: Instruction step numbers overlaid from FIG. 9). In Screen 2, user searches summary menu 101, choosing among options to search teams 103, search statistics 104, search gamified points 105, or retrieve saved searches.

If user elects to search for teams in step 103, server script pre-loads 106 user's stats (from FIG. 2) and saves into 3 caches a) current year-to-date (YTD) statistics (Cache #1A), b) prior season statistics (Cache #1B), and c) up to 5 year history (Cache #1C). Server script 109 then retrieves from FIG. 2 position and period matched league-wide player stats, saving the result in Cache #2, in step 110.

If user selects to view league wide stats in step 104, server script retrieves form database in FIG. 2 period matched stats for all players league-wide, and server saves data in Cache 3 as step 108, and server displays Cache #3 contents as step 111.

If in step 104 user elects to search for period-to-date accumulated gamified points e.g., promotional points generated, tracked, and stored in Cache #4 step 114, and displayed in step 113 by server for user logons, usage, trivia question answers, data uploads, YTD ranking of user's stats vs. league, etc.), server script 112 calculates points based on user participation, stats, etc.

### Screen 3, Step 102

(Note: Instruction step numbers overlaid from FIG. 9). In step 115, server displays user selectable default 116 and custom 117a options for a second-degree search of position and period matched player attributes. If in step 116, user selects default option for server algorithm to select matching player stats, server then retrieves from database previous user selected 106 period specific data from corresponding Cache #1A, 1B, or 1C. Server script then merges user's applicable performance data from Cache 1A, 1B, or 1C ranked attributes format in database from FIG. 6a with server then saving resulting data files Cache 5 (corresponding to merged data from Cache 1A into database from FIG. 6a), Cache 6 (corresponding to merged data from Cache 1B into database from FIG. 6a), or Cache 7 (corresponding to merged data from Cache 1C into database from FIG. 6a). In steps 129a (current year data), 131a (prior year data), and 133a (5 year historical data) server script then merges league-wide period specific data previously stored in Cache #2 with ranked attribute format in FIG. 6, stored in Cache 8a (current year data from Cache 2A) as step 130a, Cache 9a (prior year data from Cache 2B) as step 132a, and Cache 10a (5 year historical data from Cache 2C) as step 134a.

Alternatively, if, in step 117a, user selects the custom option, user selects period, and server retrieves from database user's matching previously saved data from corresponding Cache 1A (current year data), Cache 1B (prior year data), or Cache 1C (5 year history). Server script then merges user's applicable performance data from Cache 1A, 1B, or 1C ranked attributes format in database from FIG. 6 with server then saving resulting data files Cache 5 (corresponding to merged data from Cache 1A into database from FIG. 6a), Cache 6 (corresponding to merged data from Cache 1B into database from FIG. 6a), or Cache 7 (corresponding to merged data from Cache 1C into database from FIG. 6a). In steps 129b (current year data), 131b (prior year data), and 133b (5 year historical data) server script then merges league-wide period specific data previously stored in Cache #2 with user ranked attribute format in FIG. 6, stored in Cache 8b (current year data from Cache 2A) as step 130b, Cache 9b (prior year data from Cache 2B) as step 132b, and Cache 10b (5 year historical data from Cache 2C) as step 134b.

### Screen 4, Step 103

(Note: Instruction step numbers overlaid from FIG. 9). User arrives at third-degree search option 135 to choose between current YTD data (steps 1 and 2 below), prior season data (steps 3 and 4 below), and 5 year historical data (steps 5 and 6 below);

1) predictive statistical analysis 139, whereby a script performs regression analysis 139 using default attributes (i.e., player position specific, period specific, statistics ranked and formatted per categories in FIG. 6a) retrieved from cache #8a in step 130a, with the new regression data file saved in cache #11a, as step 145a, data contents of cache #11a displayed in step 150, or
2) non-predictive statistical analysis 140 based on data retrieved from cache #8b, with the new non-regression data file saved in cache #11b as step 145b, data contents of cache #11b displayed in step 150, or
3) predictive statistical analysis 141, whereby a script performs regression analysis 141 using default attributes (i.e., player position specific, period specific, statistics ranked and formatted per categories in FIG. 6a), retrieved from cache #9a in step 132, with the new regression data file saved in cache #12a, as step 137, data contents of cache #12a displayed in step 150 or
4) non-predictive statistical analysis 142 based on data retrieved from cache #10a, with the new non-regression data file saved in cache #12b as step 147, data contents of cache #12b displayed in step 150.
5) predictive statistical analysis 143, whereby a script performs regression analysis 148 using default attributes (i.e., player position specific, period specific, statistics ranked and formatted per categories in FIG. 6a), retrieved from cache #10a in step 134, with the new regression data file saved in cache #6, as step 137, data contents of cache #13a displayed in step 150 or
6) non-predictive statistical analysis 144 based on data retrieved from cache #10b, with the new non-regression data file saved in cache #13b as step 149, data contents of cache #13b displayed in step 150.

### Screen 5, Step 104

Display Users Stats (show applicable FIG. 9 Caches, 8, 9, 10, 11, 12, and 13) and
Comparable Players Stas (show applicable FIG. 9 Caches, 8, 9, 10, 11, 12, and 13)

### Screen 6, Step 105

(Note: Instruction step numbers overlaid from FIG. 9). In step 151, user chooses between 1) default server algorithm selection and subtraction of current roster matched position player's statistics from roster from corresponding user chosen steps 139 (current YTD data), 141 (prior season data) or 143 (5 yr historical data), or 2) custom user selection and subtraction of current roster matched position player's statistics from roster, step 140 (current YTD data), 142 (prior season data), or 144 (5 yr historical data). If user selects default step 139. 141, or 143, result is stored in cache #14, step 154. If user selects custom steps 140, 142, or 144, the result stored in cache #15, as step 155.

### Screen 7, Step 106

(Note: Instruction step numbers overlaid from FIG. 9). User then chooses 156 between default server algorithm selection and addition (of previous user selected Cache #11a or Cache #12a or Cache #13a) matched position player's statistics to roster, step 157, or custom user selection and addition (of previous user selected Cache #11b, or Cache #12b or Cache #13b)) matched position player's statistics to roster, step 158. If user selects default step 152, result is stored in cache #16, step 159. If user selects custom, the result stored in cache #17, as step 160.

### Screen 8, Step 107

(Note: Instruction step numbers overlaid from FIG. 9). In step 161, server script calculates and displays net positive gain or net negative loss for each statistical category between he added and subtracted players, and then server displays the net statistical difference between substituted players in the context of actual “before” and prospective “after” rosters.

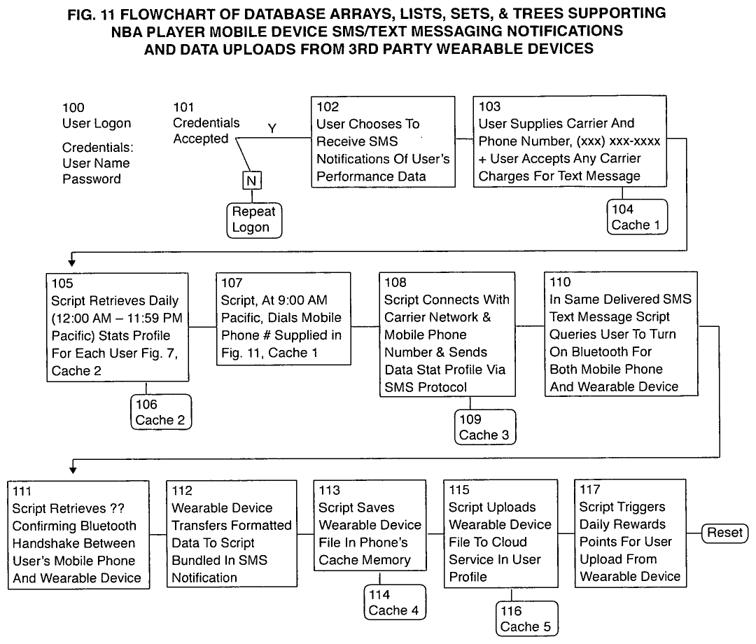

FIG. 11 is a Flowchart of Database Arrays, Lists, Sets, and Trees supporting NBA Player Mobile Device SMS/Text Messaging Notifications and Data Uploads from Third Party Wearable Devices. In step 100, user logs on to application with credentials.

After server confirmation, server displays user choice 102 to receive SMS/text message notifications of latest updated user performance data.

In 103, user supplies carrier name from a drop down menu, and phone number in the conforming North American Dialing Pattern (i.e (xxx)-xxx-xxxx). Next, user agrees to accept any relying carrier charges for text messages. Server saves data from 103 user responses in Cache 1, as step 104.

In 105, on a daily basis (12:00 am-11:59 pm Pacific) server script retrieves user/subscriber stats data laid out in data illustrated in FIG. 7. Sever saves data in Cache 2, as step 106.

Next, in step 107, on a daily basis at starting at 9:00 am Pacific, a server script prepares SMS text message file with each user's data from step 105 for outbound delivery payload to mobile phone number supplied in step 103. Server script also inserts into outbound delivery payload a standard recurring hypertext link message requesting user to turn on their wearable device Bluetooth for transmission of wearable device updated files.

In step 108, server script connects with carrier mobile network via user's previously supplied mobile number and server sends outbound data file from step 107 via SMS file format and carrier network protocol. In anticipation of possible failed transmission, server saves data to Cache 3, as step 109.

In step 110, in same text message payload from step 107, server script displays a standard recurring hypertext link message requesting user to turn on their wearable device Bluetooth for transmission of wearable device updated files.

In step 111, server script receives confirming Bluetooth handshake between user's mobile phone and user's wearable device.

In step 112, user's wearable device transfers formatted data to user's mobile phone, which in turn, transfers formatted wearable device file to server data base via server script supplied hypertext link.

In step 113, server script saves wearable device file in user's phone cache memory (Cache 4), as step 114.

In step 115, server script uploads wearable device file to cloud server into users profile folder, and server cached file in server Cache 5, as step 116.

In step 117, server script triggers daily reward points corresponding to user upload of wearable device file. Step 118 resets all routines.

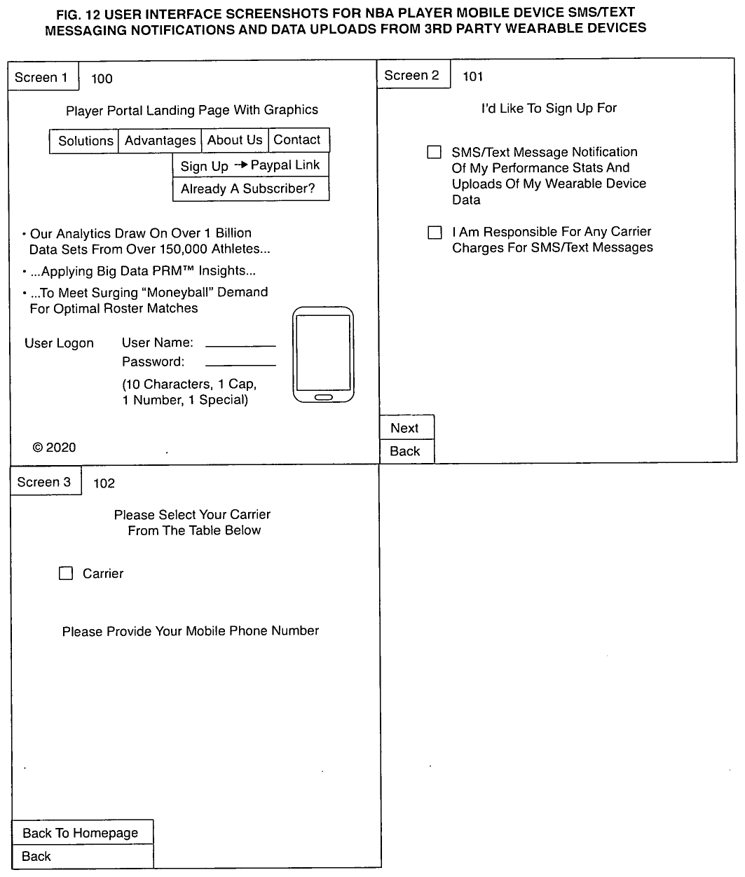

FIG. 12 is a schematic diagram showing a User Interface Screenshot for NBA Player Mobile Device SMS/Text Messaging Notifications and Data Uploads from Third Party Wearable Devices

### Screen 1 Step 100

In step 100 on Screen 1, user logs on to application with credentials, which after server confirmation, server displays Screen 2.

### Screen 2, Step 102

(Note: Instruction step numbers overlaid from FIG. 11). In Screen 2, server displays user choice 102 to receive SMS/text message notifications of latest updated user performance data.

### Screen 3, Step 103

In 103, user supplies carrier name from a drop down menu, and phone number in the conforming North American Dialing Pattern (i.e (xxx)-xxx-xxxx). Next, user agrees to accept any relying carrier charges for text messages. Server saves data from 103 user responses in Cache 1, as step 104.

What is claimed:

1. A system and methods for producing and modeling predictive data analytics for forecasting future performance in the context of multi-dimensional, sub-datasets via an automated back-end application computer server, comprising: (a) at least one internal data source storing data collected by the enterprise; (b) at least one third-party data source external to the enterprise; (c) a database containing electronic records created in accordance with data from both the internal data source and the third-party data source, each electronic record representing an association for an entity in connection with a plurality of relationships, wherein each electronic record contains a set of record characteristic values; (d) the back-end application computer server, coupled to the database, programmed to: (i) search, fetch, and access the electronic records in the database enabled by deploying a uniquely defined Composite team and player identity (Composite ID) numbering algorithm, (ii) automatically designate a first sub-set of the set of record characteristic values of each electronic record as fixed effect dependent variables, (iii) automatically designate a second sub-set of the set of record characteristic values of each electronic record as random effect independent variables, (iv) generate, by a data analytics mixed effect predictive model based on the fixed effect dependent variables and the random effect independent variables, a future performance estimation value.

2. Method of claim 1, wherein a database is programmed to search, fetch, and access the electronic records in the database enabled by deploying a uniquely defined Composite team and player identity (Composite ID) numbering algorithm to associate, arrange, store, retrieve, compare, and manipulate player profiles containing data and analytics to associate and track player statistics by their team+position+order on roster depth charts to enable “apple-apple” (i.e., same player position, same player depth on roster depth chart) comparison and substitutions of player statistics between teams.

3. The system of claim 1, wherein the future forecast of future performance data is done so by regressing data sets in two directions (forward and reverse regression) to lay sub-roster datasets in a variety of rotational contexts, in the process, uniquely discovering underlying data relationships useful in creating accurate predictions of how data will behave against a backdrop of fixed and variable conditions. Forward and reverse regressions are delivered in the modalities of teams searching for players and players searching for teams, respectively, with said regression method being uniquely performed in the context of team roster position depth (first string, second string, third string, etc. . . . ), as independent variables with said regression method uniquely and consequentially enabled by the present invention's Composite Database IDs to associate, arrange, store, search, fetch, retrieve, compare, and manipulate player profiles containing data and analytics (unique team and player Identity (ID) Number Definition).

4. Method of claim 3, wherein the script generated regression is produced in the context of roster position depth and is controlled for independent variables player age, and pooled historical age-driven factors for injury, minutes played, and load management.

5. The system of claim 1, wherein the methods and system uniquely utilizes robust modeling inclusive of non-traditional datasets, including, but not limited to, in the case of a basketball player analysis, the inclusion of such historical physiological bio data may show trends of increasing or decreasing ability to facilitate peak work demand as a possible predictor of future performance, in addition to traditional analytics focus on points, rebounds, field goal percentage, etc.

6. The system of claim 1, wherein to use the system, a user first inputs data commands to drive the creation of analytics, the execution and presentation of which is uniquely performed in a low friction user interface display and user experience in a manner that increases usage and intelligence.

7. The system of claim 1, wherein the methods and system disclosed uniquely enable machine learning to allow users to model and learn from data, in a plurality of relationships among datasets, enabling users to adapt to changing environments and situations, including converting data-to-insights to roster moves.

8. The system of claim 1, wherein the methods and system disclosed uniquely enable computer simulation to allow users to model and learn from data, in a plurality of relationships among datasets, enabling users to adapt to changing environments and situations, including converting data-to-insights to roster moves.

9. The system of claim 1, wherein the methods and system disclosed uniquely enable optimal dataset pairing, in a plurality of relationships among datasets, searches, and decision making, by way of example, for roster matches, team searches, and contract negotiations.
It should be apparent to one skilled in the art that the described embodiments and above claims may be modified in form to be optimized for a wide variety of situations.
